(19) United States
(12) Patent Application Publication
(10) Pub. No.: US 2023/0139112 A1
(43) Pub. Date: May 4, 2023

(54) WIRE-LUMINOUS MARQUEE STRING

(71) Applicant: Ling QIN, Dongguan City (CN)

(72) Inventor: Ling QIN, Dongguan City (CN)

(21) Appl. No.: 17/530,494

(22) Filed: Nov. 19, 2021

(30) Foreign Application Priority Data
Nov. 1, 2021 (CN) 202122644885.7

(51) Int. Cl. F21S 4/10

(52) U.S. Cl. CPC F21S 4/10

(57) ABSTRACT

The present application relates to the technical field of lighting fixtures, and more specifically to a wire-luminous marquee string, which includes a plurality of bulbs electrically connected in sequence, wherein a main wire is connected between adjacent ones of the bulbs, the main wire includes more than two electric cores tied in bundles, and a plurality of LED lamp beads are evenly distributed on the electric cores along a length direction of the electric cores; an electric input end of the bulb is connected to a solar energy storage panel, an electric adapter that can be connected to a power grid, or a mobile power supply, respectively; and the bulb includes a T-shaped connecting end covering the main wire, adjacent ones of the bulbs are connected to the main wire through the T-shaped connecting end, and the T-shaped connecting end is provided with a hook. The present application can reduce the superposed use of a plurality of lamp strings during use, and has the advantages of reducing wires and lowering costs.

### TECHNICAL FIELD

The present application relates to the technical field of lighting fixtures, and more specifically to a wire-luminous marquee string.

### BACKGROUND ART

A bulb, which refers to a lighting source that emits light and heat through electric energy, was invented by Henry Goebel (Edison actually found a suitable material, that is, invented a practical incandescent lamp, while the bulb appeared as early as 1854). The most common function of a bulb is lighting. With the development of society, different changes have taken place in the use of bulbs, which may initially be used for providing convenience for production and life. However, with the progress of society, there are significant changes in the use of bulbs, and functional lamps for different purposes such as “vehicle, environmental landscaping, and decoration” start to appear.

A marquee is one of the lighting fixtures that can be used for both decoration and lighting. Especially when a marquee is used for decorating a Christmas tree, it is necessary to first surround the Christmas tree with the marquee, and then surround the Christmas tree with a LED strip of a light-strip type, which is time-consuming and laborious, and costs of lamp string application are high.

### SUMMARY OF THE INVENTION

In view of the above disadvantages of the prior art, an objective of the present application is to provide a wire-luminous marquee string, which has the advantages of reducing the superposed use of a plurality of lamp strings during use, reducing wires and lowering costs.

The above technical objective of the present application is achieved by the following technical solution: a wire-luminous marquee string, comprising a plurality of bulbs electrically connected in sequence, wherein a main wire is connected between adjacent ones of the bulbs, the main wire comprises more than two electric cores tied in bundles, and a plurality of LED lamp beads are evenly distributed on the electric cores along a length direction of the electric cores; an electric input end of the bulb is connected to a solar energy storage panel, an electric adapter that can be connected to a power grid, or a mobile power supply, respectively; and the bulb comprises a T-shaped connecting end covering the main wire, adjacent ones of the bulbs are connected to the main wire through the T-shaped connecting end, and the T-shaped connecting end is provided with a hook.

Preferably, the solar energy storage panel and the electric adapter each are provided with a control module for controlling the bulb and the LED lamp beads.

Preferably, the main wire is wrapped with a transparent protective shell.

Preferably, a cross section of the transparent protective shell is arranged in a rectangular or circular shape.

Preferably, the transparent protective shell is provided with a support mechanism for internal space support.

Preferably, the support mechanism comprises a support plate arranged in an arch shape and a support bar extending along the periphery of the support plate, and the support bar is connected to an inner wall of the transparent protective shell.

In conclusion, the beneficial effects of the present application are as follows:

1. The solar energy storage panel is placed in external space to receive direct sunlight. The electric adapter is directly connected to the power grid through a converter. After a certain amount of electric power is stored in the solar energy storage panel, the electric power is supplied to the plurality of bulbs through the solar energy storage panel. After the electric power in the solar energy storage panel is used up, the plurality of bulbs are directly powered by the power grid connected to the electric adapter, or powered by using the mobile power supply, thereby achieving multi-scenario application and achieving the purpose of energy saving and, environmental, protection.

2. The bulb is installed through the T-shaped connecting end, and the bulb is hung by using the hook, which is easy for arrangement.

3. The LED lamp beads are distributed, on the electric cores to increase lighting brightness and cooperate with the bulbs on light emitting, thereby enhancing a lighting atmosphere of the marquee, increasing the interest and appreciation of the marquee, reducing the superposed use of a plurality of lamp strings during use. and having the advantages of reducing wires and lowering costs.

### BRIEF DESCRIPTION OF THE DRAWINGS

FIG. 1 is a schematic structural view of a connection of a plurality of bulbs according to an embodiment of the present application;

FIG. 2 is a schematic structural view of a cross section of a bulb according to an embodiment of the present application; and

FIG. 3 is a schematic structural view of a cross section of a main wire according to an embodiment of the present application.

Reference signs: 1. Bulb; 11. Solar energy storage panel; 12. Electric adapter; 13. T-shaped connecting end; 14. Hook; 2. Lamp cap; 21. Bulb shell; 3. Waterproof component 31. Abutting face; 32. Abutting ring; 4. Main wire; 41. Transparent protective shell; 42. LED lamp bead; 43. Electric core; 5. Support bar; 51. Support plate.

### DETAILED DESCRIPTION OF EMBODIMENTS

In order to make the technical problems to be solved by the present application, the technical solutions and the beneficial effects clearer, the present application is described in further detail below with reference to the accompanying drawings and embodiments. It should be understood that the specific embodiments described herein are merely used for explaining the present application, but not for limiting the present application.

It should be noted that when a component is referred to as being “fixed to” or “arranged at” a further component, it can be directly on the further component or indirectly on the further component. When a component is referred to as being “connected to” a further component, it can be directly or indirectly connected to the further component.

It should be understood that the orientation or position relationships indicated by terms “length” “width”, “upper”, “lower”, “front”, “rear”, “left”, “right”, “vertical”, “horizontal”, “top”, “bottom”, “inner”, “outer”, etc. are based on the orientation or position relationships shown in the accompanying drawings and are only for facilitating the description of the present, application and simplifying the description, rather than indicating or implying that the device or element referred to must have a particular orientation or be constructed and operated in a particular orientation, and therefore should not be interpreted as limiting the present application.

In addition, terms “first” and “second” are used merely for descriptive purposes, and should not be construed as indicating or implying relative importance or implicitly indicating the number of technical features indicated. Thus, features defined with “first” and “second” can explicitly or implicitly comprise one or more of the features. In the description of the present application, the meaning of “a plurality of” is two or more, unless otherwise explicitly and specifically defined.

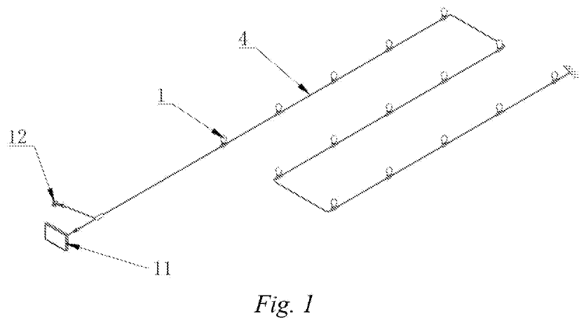

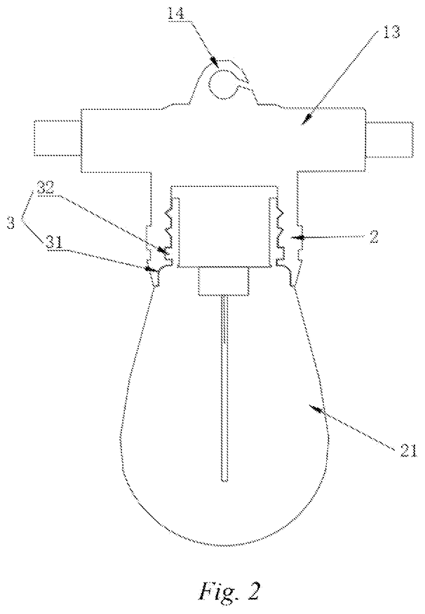

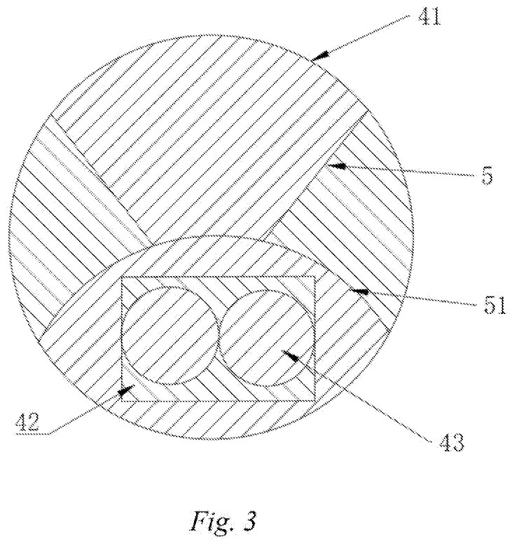

Referring to FIGS. 1 to 3, a wire-luminous marquee string comprises a plurality of bulbs 1 electrically connected in sequence. A main wire 4 is connected between adjacent ones of the bulbs 1, the main wire 4 comprises more than two electric cores 43 tied in bundles, and a plurality of LED lamp beads 42 are evenly distributed on the electric cores 43 along a length direction of the electric cores; an, electric input end of the bulb 1 is connected to a solar energy storage panel 11 and an electric adapter 12 that can be connected to a power grid, respectively; and the bulb 1 comprises a T-shaped connecting end 13 covering the main wire, the T-shaped connecting end 13 is provided on the main wire between adjacent ones of the bulbs 1, and the T-shaped connecting end 13 is provided with a hook 14.

The solar energy storage panel 11 is placed in external space to receive direct sunlight. The electric adapter 12 is directly connected to the power grid through a converter. After a certain amount of electric power is stored in the solar energy storage panel 11, the electric power is supplied to the plurality of bulbs 1 through the solar energy storage panel 11. After the electric power in the solar energy storage panel 11 is used up, the plurality of bulbs 1 are directly powered by the power grid connected to the electric adapter 12, or powered by using a mobile power supply, thereby achieving multi-scenario application and achieving the purpose of energy saving and environmental protection.

In addition, the bulb 1 is installed through the T-shaped connecting end 13, and the bulb 1 is hung by using the hook 14, which is easy for arrangement.

Moreover, the LED lamp beads 42 are distributed on the electric cores 43 to increase lighting brightness and cooperate with the bulbs 1 on light emitting, thereby enhancing a lighting atmosphere of the marquee, increasing the interest and appreciation of the marquee, reducing the superposed use of a plurality of lamp strings during use, and having the advantages of reducing wires and lowering costs.

Specifically, the solar energy storage panel 11 and the electric adapter 12 each are provided with a control module for controlling the bulb 1 and the LED lamp beads 42. The control module can control changes in colors of the bulb 1 and the LED lamp beads 42 and turning on of the bulb 1 and the LED lamp beads 42. The control module in this embodiment is an SC200 controller.

Specifically, the bulb 1 further comprises a lamp cap 2 and a shell of the bulb 1 that is screwed into the lamp cap 2, and a waterproof component 3 is provided between the lamp cap 2 and the shell of the bulb 1.

The waterproof component 3 can effectively block external water, to ensure a sealed environment inside the shell of the bulb 1.

Specifically, the waterproof component 3 comprises an abutting face 31 provided on an inner wall of the lamp cap 2 and an abutting ring 32 provided on the outside of the shell of the bulb 1, the abutting ring 32 is circumferentially arranged around the shell of bulb 1, and the abutting face 31 is obliquely arranged from top to bottom.

After the shell of bulb 1 is screwed into the lamp cap 2, the first layer of waterproofing is achieved by the abutting ring 32 abutting against the abutting face 31, and the second layer of waterproofing is achieved by screw locking, thereby ensuring the sealed environment inside the shell of bulb 1.

Specifically, the main wire 4 is wrapped with a transparent protective shell 41.

The transparent protective shell 41 in this embodiment is a pc plastic product, and is used for waterproofing and moisture proofing. In addition, the LED lamp beads 42 are copper wire lamps, and the electric cores 43 are copper wires.

Specifically, a cross section of the transparent protective shell 41 is arranged in a rectangular or circular shape.

The cross section of the transparent protective shell 41 is arranged in a rectangular shape, which can facilitate installation and placement of the main wire 4. The cross section of the transparent protective shell 41 is arranged in a circular shape, which can diffuse luminous light of the main wire 4 as much as possible.

Preferably, the transparent protective shell 41 is provided with a support mechanism for internal space support.

In order to prevent the main wire 4 from being damaged and twisted by the impact of an external force, internal space of the transparent protective shell 41 is supported by the support mechanism, thereby protecting a working environment of the main wire 4 and prolonging a service life of a product.

Preferably, the support mechanism comprises a support plate 51 arranged in an arch shape and a support, bar 5 extending along the periphery of the support plate 51, and the support bar 5 is connected to an inner wall of the transparent protective shell 41.

The support plate 51 and the inner wall of the transparent protective shell 41 form a space for placing the main wire 4, and the support plate 51 is arranged in the arch shape, thereby effectively increasing light-diffusion intensity of the main wire 4; and the support plate 51 is supported by the support bar 5, thereby further ensuring a support shape of the support plate 51.

The above embodiment is merely an explanation of the present application, and is not a limitation to the present application. After reading this specification, those skilled in the art can make modifications to the embodiment without creative contributions as needed, but the modifications are protected by the patent law as long as they fall within the scope of the claims of the present application.

1. A wire-luminous marquee string, comprising a plurality of bulbs electrically connected in sequence, wherein a main wire is connected between adjacent ones of the bulbs, the main wire comprises more than two electric cores tied in bundles, and a plurality of LED lamp beads are evenly distributed on the electric cores along a length direction of the electric cores; an electric input end of the bulb is connected to a solar energy storage panel, an electric adapter that can be connected to a power grid, or a mobile power supply, respectively; and the bulb comprises a T-shaped connecting end covering the main wire, adjacent ones of the bulbs are connected to the main wire through the T-shaped connecting end, and the T-shaped connecting end is provided with a hook.

2. The wire-luminous marquee string according to claim 1, wherein the solar energy storage panel and the electric adapter each are provided with a control module for controlling the bulb and the LED lamp beads.

3. The wire-luminous marquee string according to claim 1, wherein the main wire is wrapped with a transparent protective shell.

4. The wire-luminous marquee string according to claim 3, wherein a cross section of the transparent protective shell is arranged in a rectangular or circular shape.

5. The wire-luminous marquee string according to claim 3, wherein the transparent protective shell is provided with a support mechanism for internal space support.

6. The wire-luminous marquee string according to claim 5, wherein the support mechanism comprises a support plate arranged in an arch shape and a support bar extending along the periphery of the support plate, and the support bar is connected to an inner wall of the transparent protective shell.
